(19) United States
(12) Patent Application Publication
(10) Pub. No.: US 2017/0254622 A1
(43) Pub. Date: Sep. 7, 2017

(54) AIRCRAFT FORCE MULTIPLICATION

(71) Applicant: Northrop Grumman Systems Corporation, Falls Church, VA (US)

(72) Inventors: David W. Evans, Signal Hill, CA (US); Gregory L. Larson, Palos Verdes Estate, CA (US); Jeffrey M. Yang, Signal Hill, CA (US)

(21) Appl. No.: 15/057,574

(22) Filed: Mar. 1, 2016

(51) Int. Cl. F41G 7/22; B64D 7/00; F41G 7/00; B64C 39/02

(52) U.S. Cl. CPC F41G 7/2206; B64C 39/024; B64D 7/00; F41G 7/2233; F41G 7/007; B64C 2201/12; B64C 2201/146

(57) ABSTRACT

A manned aircraft and unmanned aerial vehicles (UAVs) fly on a mission as a team. The UAVs carry additional weapons and/or munitions that can be controlled by the manned aircraft. The pilot of the manned aircraft selects weapons or munitions carried by either the manned aircraft or one of the UAVs. A display in the manned aircraft illustrates weapons available on both the manned aircraft and UAVs. The pilot of the manned aircraft picks a weapon from the display and then targets and fires the weapon. The targeting and guidance of the weapon can be carried out using computers on the manned aircraft and/or computers on the UAV.

### TECHNICAL FIELD

An embodiment of the present invention relates to aircraft, more particularly, to the field of aircraft weapon control.

### BACKGROUND

Currently, missions carried out by aircraft such as military aircraft are often limited by the amount of weapons or munitions that the aircraft can carry. This has been addressed by decreasing the amount of fuel carried by the aircraft. The decrease in weight resulting from carrying less fuel enables the aircraft to carry additional weapons or munitions. Unfortunately, this approach results in limiting the range of the aircraft or requiring aerial refueling. Aerial refueling can extend the range of the aircraft; however, this requires additional logistical support and planning. This additional logistical planning reduces the overall mission reaction time.

### SUMMARY

An embodiment of the current invention addresses the above-described limitations by using unmanned aerial vehicles (UAVs) to carry additional weapons and/or munitions that can be controlled by a manned aircraft. By using the UAVs to carry additional weapons, the manned aircraft does not have to sacrifice fuel for weapons carrying capability while providing the pilot with a large payload of weapons to deploy.

The manned aircraft and the UAVs fly on a mission as a team. The pilot or pilots of the manned aircraft select weapons or munitions carried by either the manned aircraft or one of the UAVs. A display in the manned aircraft illustrates weapons available on both the manned and UAVs. The pilot of the manned aircraft picks a weapon from the display and then targets and fires the weapon as if it were onboard his aircraft. The targeting and guidance of the weapon can be carried out using weapon control computers on the manned aircraft and/or computers on the UAVs.

### BRIEF DESCRIPTION OF THE DRAWINGS

FIG. 1 illustrates a team comprising a manned aircraft and several UAVs;

FIGS. 2A, 2B and 2C illustrate the process for deploying weapons from a manned aircraft or one of several UAVs; and

FIGS. 3A and 3B illustrate block diagrams of the manned aircraft and UAVs weapons control.

### DETAILED DESCRIPTION

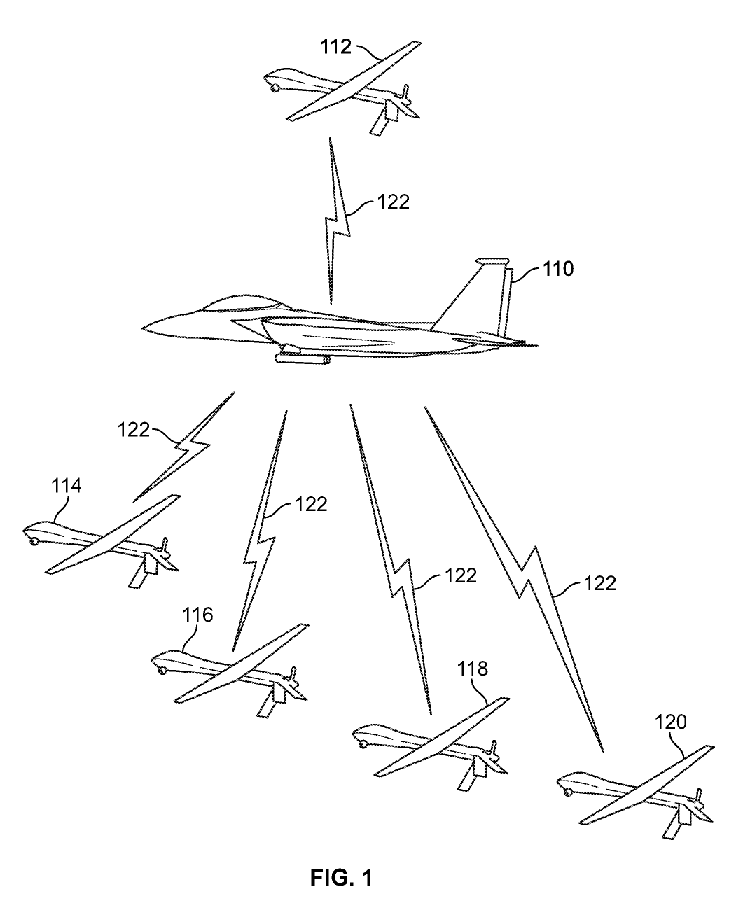

FIG. 1 illustrates manned aircraft 110 and UAVs 112, 114, 116, 118 and 120. The manned aircraft as well as the UAVs may carry weapons or munitions. Each of the aircraft may carry a similar complement of weapons or munitions or they may carry differing types of weapons. For example, manned aircraft 110 may carry primarily air-to-air missiles while UAVs may carry laser or GPS guided bombs.

Manned aircraft 110 is in communication with the UAVs using secure communication data link such as link 122. Secure communication link 122 may be implemented using a link such as LINK-16, which is a well-known encrypted data link. Link 122 may also be implemented using a Multifunction Advanced Data Link (MADL), which is a fast switching narrow directional communications data link between stealth aircraft. MADL began as a method to coordinate between F-35 aircraft (the Joint Strike Fighter), and it provides secure transmission throughput, low latency, frequency-hopping and anti-jamming capability using phased Array Antenna Assemblies (AAAs) that send and receive tightly directed radio signals. MADL uses the Ku band.

Secure communication link 122 is used to exchange information between the aircraft. For example, the UAVs provide information on available weapons to manned aircraft 110. Additionally, information is provided from manned aircraft 110 to UAVs regarding information such as weapon targeting information, fire commands and weapon guidance information. It should be noted that communication link 122 may also provide information such as targeting information and weapon guidance information to manned aircraft 110.

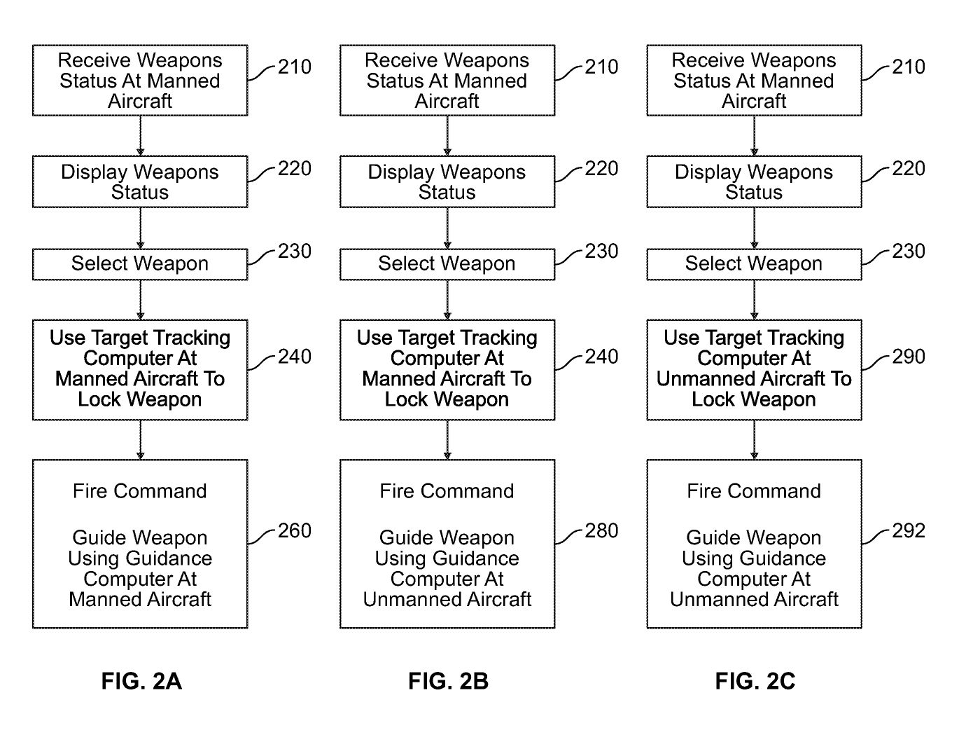

FIG. 2A illustrates weapon deployment using a targeting computer and weapon guidance computer located in the manned aircraft. In step 210 manned aircraft 110 receives weapon status information from one or more UAVs. In step 220, the received weapon status information is illustrated on the display for the pilot's use. The illustrated weapon status information may include the status of weapons carried by the manned aircraft. The illustration of weapon status indicates the type of weapons, their availability and which aircraft is carrying the weapon. This information may be enhanced by showing different types of weapons using different symbols or colors, and by illustrating which aircraft is carrying a weapon using different symbols or colors. For example, there may be a different color used for weapons carried by different aircraft; the color red may be used for weapons carried by manned aircraft 110 and the color green may be used for weapons carried by aircraft 114 while yet another color may be used for weapons carried by aircraft 116. Symbols such as squares or triangles may be used to indicate types of weapons and a strikethrough may be used to indicate a weapon is not available. In step 230, the pilot may select a weapon for deployment using a pilot interface such as a joystick or touch screen. In step 240, the pilot may use a pilot interface such as a joystick to communicate with a targeting computer located in the manned aircraft to lock a weapon onto a target. The weapon achieves the necessary lock onto its target through the manned aircraft's target tracking and guidance computers, which pass the target information to the weapon's integrated guidance sensors such that the weapon can compute a terminal guidance solution to its intended target. In step 260, the pilot provides a fire command using input such as a trigger and the target information is passed to a guidance computer located in the manned aircraft that guides the weapon to the target. It should be noted that the targeting computer as well as the guidance computer provides target information to the weapon to be deployed. Post deployment, the guidance computer may continue to communicate with the deployed weapon to assist in guiding the weapon to the target. If the weapon is not located on the manned aircraft, the targeting information as well as the guidance information is passed to the weapon using a secure link such a secure link 122.

FIG. 2B illustrates weapon deployment using a targeting computer located in the manned aircraft and a weapon guidance computer located in the unmanned aircraft. In this embodiment, steps 210 to 240 are followed; however, after step 240, step 280 is executed. In step 280 the pilot provides a fire command and targeting information is passed to a guidance computer located on the unmanned aircraft. This information is passed over a secure link such as secure link 122. Post deployment, the guidance computer may continue to communicate with the deployed weapon to assist in guiding the weapon to the target.

FIG. 2C illustrates weapon deployment using a targeting computer and a guidance computer located on the unmanned aircraft. In this embodiment, steps 210 through 230 are followed; however, step 290 is then executed where a pilot uses a pilot interface to communicate over secure communication link 122 with a targeting computer located on the unmanned aircraft to lock a weapon onto a target. In step 292 the pilot provides a fire command and targeting information is passed to the guidance computer located on the unmanned aircraft. The fire command is communicated over secure communication 122. Post deployment, the guidance computer may continue to communicate with the deployed weapon to assist in guiding the weapon to the target.

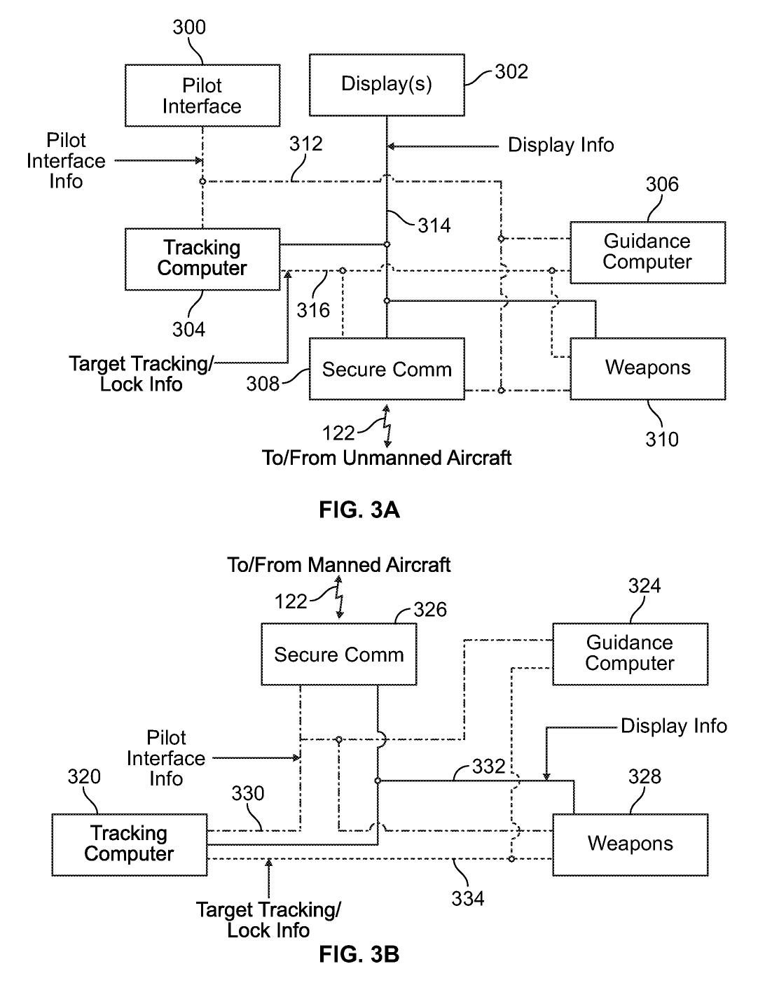

FIGS. 3A and 3B illustrate weapon control systems for manned and unmanned aircraft, respectively. Communications between the manned and unmanned aircraft weapon control systems are carried out over secure communication link 122.

FIG. 3A illustrates a weapons control system on a manned aircraft. Pilot interface 300 may be implemented using devices such as joysticks, triggers, buttons, switches and touchscreens. Display or displays 302 are used to illustrate weapon information and status as well as potential targets and aircraft information to the pilot. These displays may be implemented using devices such as LCDs, LED displays, other types of displays including color displays, gauges or lights. Target tracking computer 304 and weapon guidance computer 306 may be implemented using microcomputer chips or microprocessor chips, read-only memories, random-access memories, solid-state drives, magnetic drives, optical drives and programmable logic modules. It is also possible to implement target tracking computer 304 and guidance computer 306 as a single mission computer. Secure communication module 308 may be implemented using for example, a radio frequency transceiver or an optical transceiver, an encryption decryption module, a microcomputer or microprocessor, and memories such as read-only memories and random-access memories. Weapons 310 may be weapons such as air-to-air missiles, GPS guided bombs or laser-guided bombs.

Pilot interface 300, tracking computer 304, guidance computer 306, weapons 310 and secure communication module 308 include an interface to communicate over communication bus 312. Communication bus 312 may be implemented using well-known standard protocols such as USB or Ethernet. Bus 312 is used to communicate pilot inputs such as weapon selection, target lock information and fire commands to tracking computer 304 and guidance computer 306 as well as weapons 310. This information is also provided to secure communication module 308 for transmission over secure communication link 122 when needed for deploying weapons on unmanned aircraft.

Displays 302, tracking computer 304, weapons 310 and secure communication module 308 include an interface to communicate over communication bus or link 314. Communication bus 314 may be implemented using well-known standard protocols such as USB or Ethernet. Communication bus 314 is used to provide tracking computer information to the pilot using display 302 and to provide weapons information from the manned aircraft as well as weapons information from the unmanned aircraft via secure communications module 308 to the pilot using display 302.

Tracking computer 304, guidance computer 306, secure communications module 308 and weapons 310 include interface to communicate over communication bus or link 316. Communication bus 316 may be implemented using well-known standard protocols such as USB or Ethernet. Communication bus 316 is used to provide information from tracking computer 304 to guidance computer 306 and weapons 310. This target information is used by the guidance computer and weapon after the weapon is fired to guide the weapon to the target. This information is also provided to secure communications module 308 for deploying weapons from unmanned aircraft using secure communication link 122.

FIG. 3B illustrates weapons control system on an unmanned aircraft. Target tracking computer 320 and weapon guidance computer 324 may be implemented using microcomputer chips or microprocessor chips, read-only memories, random-access memories, solid-state drives, magnetic drives, optical drives and programmable logic modules. It is also possible to implement target tracking computer 320 and guidance computer 324 as a single mission computer. Secure communication module 326 may be implemented using for example, a radio frequency transceiver or an optical transceiver, an encryption decryption module, a microcomputer or microprocessor, and memories such as read-only memories and random-access memories. Weapons 328 may be weapons such as air-to-air missiles, GPS guided bombs or laser-guided bombs.

Tracking computer 320, guidance computer 324, weapons 328 and secure communication module 326 include an interface to communicate over communication bus or link 330. Communication bus 330 may be implemented using well-known standard protocols such as USB or Ethernet. Bus 330 is used to communicate pilot inputs received via secure communications link 122. These pilot inputs include information such as weapon selection, target lock information and fire commands to tracking computer 320 and guidance computer 324 as well as weapons 328.

Tracking computer 320, weapons 328 and secure communication module 326 include an interface to communicate over communication bus or link 332. Communication bus 332 may be implemented using well-known standard protocols such as USB or Ethernet. Communication bus 332 is used to provide information to the pilot via secure communication module 326, secure communications link 122 and display 302. Bus 332 provides tracking computer information from tracking computer 320 and weapons information from weapons 328 to secure communication module 326.

Tracking computer 320, guidance computer 324 and weapons 310 include interface to communicate over communication bus or link 334. Communication bus 334 may be implemented using well-known standard protocols such as USB or Ethernet. Communication bus 334 is used to provide information from tracking computer 320 to guidance computer 324 and weapons 328. This target information is used by the guidance computer and weapon after the weapon is fired to guide the weapon to the target.

What is claimed is:

1. A method, comprising the steps of:
receiving a received weapons status from an unmanned aircraft at a manned aircraft, the received weapons status associated with weapons carried by the unmanned aircraft;
displaying at the manned aircraft, an illustration of the received weapons status;
selecting a weapon using the illustration;
using a target tracking computer to lock the selected weapon to a target;
communicating target information to a weapon guidance computer; and
using the weapons guidance computer to guide the selected weapon to the target.

2. The process of claim 1, where the target tracking computer in on the manned aircraft.

3. The process of claim 2, where the weapon guidance computer is on the manned aircraft.

4. The process of claim 2, where the weapon guidance computer is on the unmanned aircraft.

5. The process of claim 1, where the target tracking computer and the weapon guidance computer are on the unmanned aircraft.

6. The process of claim 1, wherein the step of receiving comprising receiving the received weapons status from a plurality unmanned aircraft.

7. The process of claim 6, wherein the step of displaying comprises displaying an illustration of the received weapons status from each unmanned aircraft in the plurality of unmanned aircraft.

8. The process of claim 7, wherein the step of displaying comprises using different colors to display weapons statuses from different unmanned aircraft.

9. The process of claim 1, wherein the step of displaying comprises displaying an illustration of a weapons status of weapons carried by the manned aircraft.

10. The process of claim 9, wherein the step of displaying comprises using different colors to display weapons statuses from different aircraft.

11. A method, comprising the steps of:
receiving a received weapons status from an unmanned aircraft at a manned aircraft, the received weapons status associated with weapons carried by the unmanned aircraft;
displaying at the manned aircraft, an illustration of the received weapons status;
selecting a weapon using the illustration; and
firing the selected weapon.

12. The process of claim 11, wherein the step of receiving comprising receiving the received weapons status from a plurality unmanned aircraft.

13. The process of claim 12, wherein the step of displaying comprises displaying an illustration of the received weapons status from each unmanned aircraft in the plurality of unmanned aircraft.

14. The process of claim 13, wherein the step of displaying comprises using different colors to display weapons statuses from different unmanned aircraft.

15. The process of claim 11, wherein the step of displaying comprises displaying an illustration of a weapons status of weapons carried by the manned aircraft.

16. The process of claim 15, wherein the step of displaying comprises using different colors to display weapons statuses from different aircraft.
